(19) United States
(12) Patent Application Publication
(10) Pub. No.: US 2026/0340012 A1
(43) Pub. Date: Oct. 29, 2026

(54) Recursive Symbolic Cognitive Operating System

(71) Applicant: Chadwick Alexander Simon, Alameda, CA (US)

(72) Inventor: Chadwick Alexander Simon, Alameda, CA (US)

(21) Appl. No.: 19/656,955

(22) Filed: Apr. 23, 2026

Related U.S. Application Data
(60) Provisional application No. 63/794,337, filed on Apr. 25, 2025.

(51) Int. Cl. G06F 16/335

(52) U.S. Cl. CPC G06F 16/337

(57) ABSTRACT

A computer-implemented cognitive operating system structures user language into symbolic cognitive units and organizes the symbolic cognitive units into recursively re-enterable session structures. The system evaluates newly created or modified symbolic cognitive units relative to previously stored symbolic cognitive units to detect recurrence based on symbolic content associated with present and prior user expressions. When a recurrence condition is satisfied, the system may initiate a bisociation operation that combines present input with one or more prior symbolic cognitive units and obtains reflective output from a remote generation component that does not require persistent user-specific memory after request completion. Long-term cognitive state remains stored under user control, thereby enabling recursive re-entry, re-evaluation, and privacy-preserving reflective generation.

### 2. CROSS-REFERENCE TO RELATED APPLICATIONS

This application claims priority to and the benefit of U.S. Provisional Patent Application No. 63/794,337, filed on Apr. 25, 2025, entitled “Recursive Symbolic Interface for Cognitive Reflection and Behavioral Modulation.” The entire contents of the provisional application are incorporated herein by reference.

### 3. FIELD OF THE INVENTION

The invention relates to human-computer interaction, symbolic cognitive architectures, recursive reflection systems, and artificial intelligence-assisted reflective generation.

More particularly, the invention relates to systems and methods for transforming user-generated language into structured symbolic cognitive units, organizing those units into recursively re-enterable session structures, detecting recurrence across stored symbolic units, generating higher-order reflective output by bisociation of present and prior symbolic content, and performing reflective generation without requiring persistent user-specific memory at a remote generation component.

### 4. BACKGROUND OF THE INVENTION

Conventional conversational interfaces generally process user language as transient exchanges rather than as structured symbolic units that can be revisited, recombined, and recursively reprocessed over time. Although some systems store histories, the stored material is typically maintained as message logs rather than as symbolic cognitive structures designed for pattern recurrence, recursive re-entry, or machine-assisted reflective recombination.

Journaling systems ordinarily store text as static entries. Such systems do not typically organize user expressions into reusable symbolic units within re-enterable session structures, do not detect recurrence across sessions in a way guided by user symbolism, and do not generate higher-order reflective output by combining present expressions with prior symbolic content.

There remains a need for a computer-implemented architecture that: (i) converts user language into symbolic cognitive units; (ii) groups those units into recursively re-enterable session structures; (iii) identifies recurrence across prior symbolic units; (iv) generates bisociated reflective output by combining present and historical content; and (v) performs reflective generation without requiring persistent user-specific memory at a remote generation component.

### 5. SUMMARY OF THE INVENTION

In some embodiments, the invention provides a computer-implemented cognitive operating system that structures user language into symbolic cognitive units and organizes those symbolic cognitive units into recursively re-enterable session structures.

In some embodiments, each symbolic cognitive unit comprises at least user input text and associated metadata. In some embodiments, the symbolic cognitive unit further comprises one or more symbolic tags, one or more timestamps, one or more symbolic operators, associated reflective output, and optional references to one or more prior symbolic cognitive units used in bisociation. In some embodiments, such symbolic cognitive units may be referred to as MirrorLines.

In some embodiments, each recursive session structure comprises an ordered collection of associated symbolic cognitive units together with session-level metadata. In some embodiments, the recursive session structure includes a session identifier, a start timestamp, an optional completion timestamp, a title, and one or more session-level symbolic tags. In some embodiments, such recursive session structures may be referred to as LoopSessions.

In some embodiments, the system evaluates a newly created or modified symbolic cognitive unit relative to previously stored symbolic cognitive units to detect recurrence. Such recurrence may be based on one or more symbolic tags, one or more symbolic operators, one or more prior symbolic relationships, or combinations thereof.

In some embodiments, when a recurrence condition is satisfied, the system selects one or more prior symbolic cognitive units and combines them with present user input to form a bisociated input representation. Reflective output based on the bisociated input representation is then generated and stored locally in association with the current symbolic cognitive unit or in a new symbolic cognitive unit linked to the source symbolic cognitive units.

In some embodiments, the system operates according to a local-control architecture in which long-term cognitive state remains under control of a user device or user-controlled storage, while a reflective generation component operates without maintaining persistent user-specific memory after completion of a request.

The invention therefore provides a specific computer-implemented architecture for symbolic reflection, recursive session processing, bisociation, and non-memory reflective generation distinct from conventional chat interfaces and static journaling systems.

### 6. BRIEF DESCRIPTION OF THE DRAWINGS

FIG. 1 is a block diagram of an example system architecture illustrating on-device components and a remote reflective generation component.

FIG. 2 is a diagram of an example data structure for a symbolic cognitive unit.

FIG. 3 is a diagram of an example data structure for a recursive session structure.

FIG. 4 is a flow diagram illustrating an example cognitive reflection pipeline for generating and storing symbolic cognitive units, including bisociative processing.

FIG. 5 is a flow diagram illustrating example recurrence detection and bisociation logic implemented in the cognitive operating system.

### 7. DETAILED DESCRIPTION OF THE INVENTION

### 7.1 System Architecture

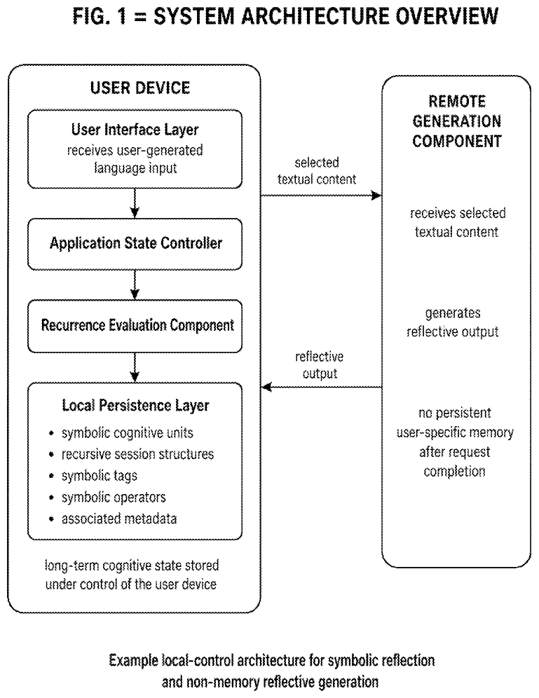

With reference to FIG. 1, a cognitive operating system is implemented using a local-control architecture. In some embodiments, the system includes an on-device computing environment comprising a user interface layer, an application state controller, a recurrence evaluation component, and a local persistence layer. The local persistence layer stores long-term cognitive state including symbolic cognitive units, recursive session structures, symbolic tags, symbolic operators, and associated metadata.

In some embodiments, the system further includes a reflective generation interface configured to transmit selected textual content to a remote generation component and to receive reflective output in response. In certain embodiments, the remote generation component does not maintain persistent user-specific memory, profile state, or session history after completion of a request.

In operation, user input is received locally. The on-device environment constructs or updates one or more symbolic cognitive units, associates those units with a recursive session structure, evaluates recurrence relative to previously stored symbolic cognitive units, and, when applicable, initiates a bisociation operation. When reflective generation is required, the system transmits selected textual content derived from present user input and optionally one or more prior symbolic cognitive units to the remote generation component. Returned reflective output is stored locally and associated with the corresponding symbolic cognitive unit or with a newly created symbolic cognitive unit linked to its source symbolic cognitive units.

In some embodiments, long-term cognitive state remains stored under control of the user, thereby enabling recursive re-entry, local re-evaluation, user-controlled deletion, and privacy-preserving operation.

### 7.1.1 Definitions

For purposes of this disclosure, the following terms are defined.

“Symbolic Cognitive Unit” refers to a structured record comprising at least user input text and associated metadata and optionally comprising associated reflective output, one or more symbolic tags, one or more symbolic operators, one or more timestamps, a session association, and one or more references to prior symbolic cognitive units.

“Recursive Session Structure” refers to a structured session container comprising an ordered collection of symbolic cognitive units and session-level metadata, the session container being re-enterable for extension, annotation, and re-evaluation.

“Symbolic Tag” refers to a label applied to or derived for a symbolic cognitive unit, wherein the label represents a semantic, identity, state, or domain marker usable for indexing, filtering, ranking, or recurrence detection.

“Symbolic Operator” refers to a syntactic or semantic marker derived from user-applied symbols, tags, or text, including but not limited to operators indicating combination, tension, directional flow, sub-context anchoring, escalation, provocation, or parallelism. Example operators include: +, /, →, ::, >>, po, and ||.

“Bisociation” refers to a computer-implemented process in which a current symbolic cognitive unit and one or more prior symbolic cognitive units originating from different temporal or contextual states are selected and combined to form a higher-order input representation used to generate reflective output while preserving linkage to the source symbolic cognitive units.

“Recursive Re-Entry” refers to retrieving and reprocessing previously stored symbolic cognitive units and session structures under a current context to support extension, annotation, recurrence detection, or additional reflective generation.

“Remote Generation Component” refers to the portion of the system that receives selected text and returns reflective output, whether implemented as a remote model, inference service, or other text-generation routine.

“Recurrence Condition” refers to a rule, threshold, or other machine-evaluated basis for determining that current symbolic content sufficiently relates to one or more prior symbolic cognitive units to justify additional reflective processing.

“Non-Memory Reflective Generation” refers to the generation of reflective output without requiring persistent user-specific memory to be retained by the remote generation component after completion of a request.

### 7.1.2 Example Deployment Embodiments

In one embodiment, the system is implemented as a mobile application executing on a smartphone or tablet. In another embodiment, the system is implemented as a desktop application executing on a personal computer. In another embodiment, the system is implemented as a web application executing within a browser environment and using local browser storage, indexed databases, or equivalent client-side persistence. In further embodiments, the system operates across multiple user devices using user-controlled synchronization or transfer mechanisms while preserving local control over long-term cognitive state.

### 7.2 Data Structures

### 7.2.1 Symbolic Cognitive Unit Structure

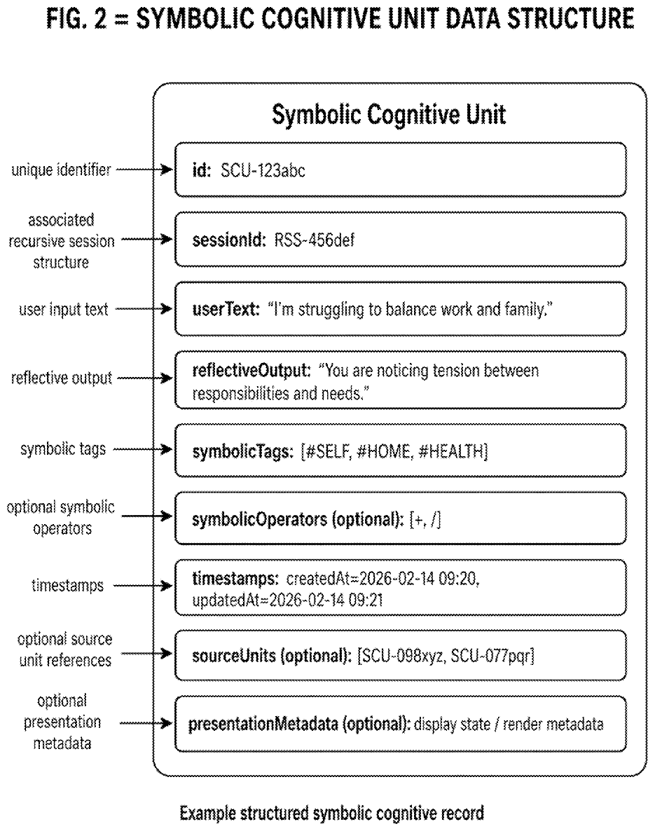

With reference to FIG. 2, a symbolic cognitive unit is stored as a structured record in a local data store. In some embodiments, a symbolic cognitive unit includes:
(a) an identifier;
(b) userText representing user input text;
(c) reflectiveOutput representing model-generated or algorithmically generated reflective output associated with the userText;
(d) one or more symbolic tags;
(e) one or more symbolic operators derived from the userText, the tags, or both;
(f) one or more timestamps;
(g) a session association; and
(h) sourceUnits representing optional references to one or more prior symbolic cognitive units used in bisociation.

In some embodiments, the symbolic cognitive unit further includes optional presentation metadata. This structure enables symbolic tagging, recurrence evaluation, source tracing, and association with recursive session structures.

### 7.2.2 Recursive Session Structure

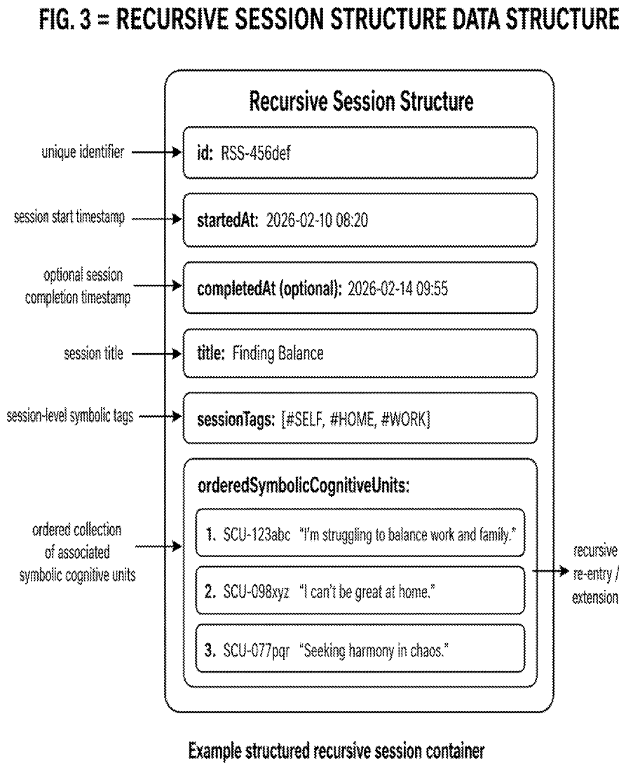

With reference to FIG. 3, a recursive session structure is stored in the local data store. In some embodiments, a recursive session structure includes:
(a) an identifier;
(b) a startedAt timestamp;
(c) an optional completedAt timestamp;
(d) a title;
(e) one or more session-level symbolic tags; and
(f) an ordered collection of associated symbolic cognitive units.

In some embodiments, the ordered collection stores symbolic cognitive unit identifiers and ordering metadata. In other embodiments, the ordered collection stores embedded symbolic cognitive unit records. Recursive session structures support recursive re-entry, extension with additional symbolic cognitive units, tag modification, annotation, and re-evaluation under updated context.

### 7.3 Processing Methods

### 7.3.1 Input Handling

User input may be received via text entry, transcribed speech, pasted content, or another input modality. In some embodiments, the system creates a provisional symbolic cognitive unit after receiving user input and before reflective output is generated. The provisional symbolic cognitive unit is associated with an existing recursive session structure or with a newly created recursive session structure.

### 7.3.2 Recurrence Evaluation

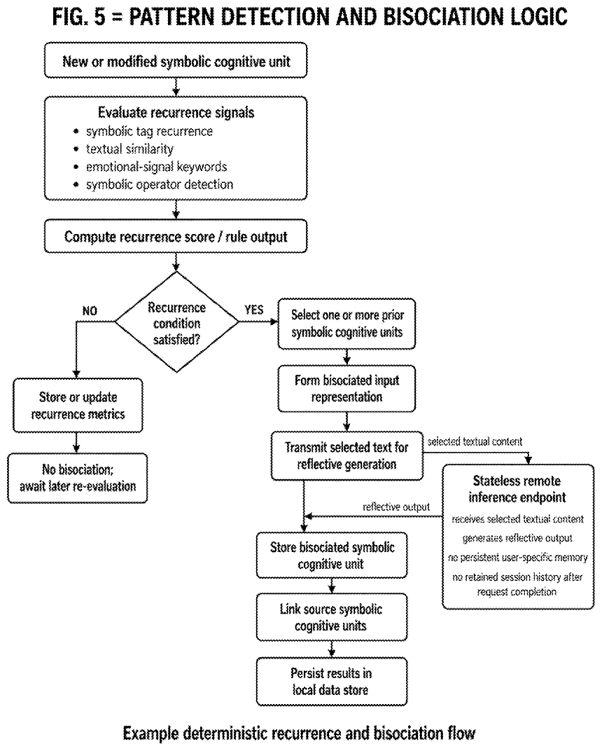

With reference to FIG. 5, each newly created or modified symbolic cognitive unit is evaluated relative to previously stored symbolic cognitive units. In some embodiments, recurrence evaluation uses one or more symbolic tags, one or more symbolic operators, one or more prior symbolic relationships, or combinations thereof. In some embodiments, the system determines whether a recurrence condition or rule has been satisfied.

### 7.3.3 Reflective Generation

If reflective output is required, the system selects textual content for transmission to the reflective generation component. In some embodiments, the selected content includes the current symbolic cognitive unit and optionally one or more prior symbolic cognitive units. Returned reflective output is stored locally as part of the current symbolic cognitive unit or as a new symbolic cognitive unit associated with the same or another recursive session structure.

### 7.3.4 Bisociation

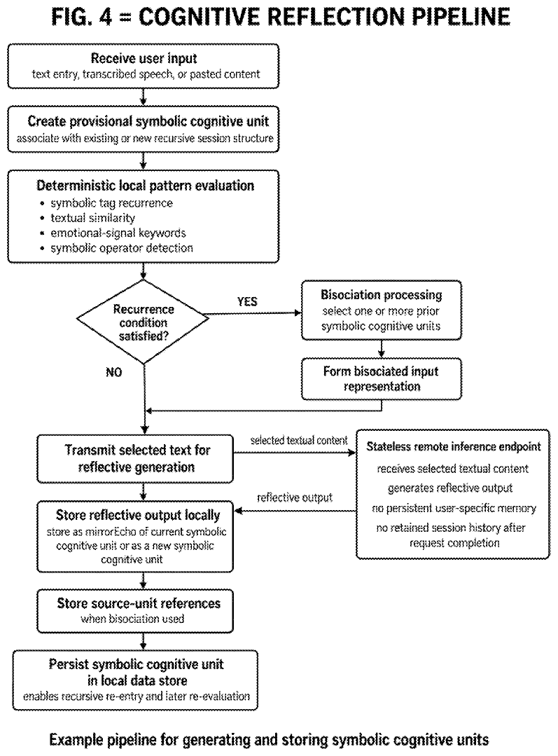

With reference to FIG. 4 and FIG. 5, when one or more recurrence conditions are satisfied, the system selects one or more prior symbolic cognitive units and combines them with present user input to form a bisociated input representation. The bisociated input representation is transmitted to the reflective generation component or to another reflective generation routine. Reflective output produced from the bisociated input representation is stored locally in a symbolic cognitive unit that preserves references to the source symbolic cognitive units.

### 7.3.5 Recursive Re-Entry and Re-Evaluation

Re-entering a recursive session structure causes the system to retrieve previously stored symbolic cognitive units and session metadata and to present them through the user interface. In some embodiments, re-entry further causes re-evaluation of one or more symbolic cognitive units under current parameters or context. The system may update symbolic tags or symbolic operators, append new symbolic cognitive units, regenerate reflective output for selected symbolic cognitive units, or generate new bisociated symbolic cognitive units.

### 8. Technical improvements and Computer-Implemented Operation

The disclosed invention is implemented using machine-readable data structures and computer-executed processing rather than as a disembodied mental process. Symbolic cognitive units and recursive session structures are persistent structured records stored in a data store and manipulated by one or more processors according to defined computer-executed routines.

The system improves reflective computing interfaces by organizing user-generated language into reusable symbolic units and recursively re-enterable session structures, detecting recurrence across stored symbolic content, and generating bisociated reflective output based on present and historical symbolic material.

The architecture further improves computer operation by separating persistent cognitive state from reflective generation. Long-term state remains under user control, while the remote generation component does not require persistent user-specific memory after request completion.

1. A computer-implemented cognitive operating system, comprising:
a local data store under control of a user device;
a reflective generation interface; and
one or more processors coupled to memory storing instructions that, when executed, cause the one or more processors to:
receive user-generated language input;
construct and store, in the local data store, a symbolic cognitive unit comprising at least user input text, one or more symbolic tags, one or more timestamps, and a session association;
associate the symbolic cognitive unit with a recursive session structure comprising an ordered collection of symbolic cognitive units;
evaluate the symbolic cognitive unit relative to previously stored symbolic cognitive units to detect recurrence;
determine, based on the recurrence, whether to initiate a bisociation operation that selects one or more prior symbolic cognitive units and forms a bisociated input representation;
transmit selected textual content derived from the symbolic cognitive unit and, when the bisociation operation is initiated, the bisociated input representation to a remote generation component;
receive reflective output from the remote generation component; and store the reflective output locally in association with the symbolic cognitive unit or in a new symbolic cognitive unit linked to one or more source symbolic cognitive units, thereby persisting long-term cognitive state locally for recursive re-entry and re-evaluation.

2. The system of claim 1, wherein the long-term cognitive state comprises symbolic cognitive units and recursive session structures stored under control of the user device.

3. The system of claim 1, wherein the remote generation component does not maintain persistent user-specific memory or session history after completion of a request.

4. The system of claim 1, wherein the recurrence is detected based at least in part on one or more symbolic tags associated with the symbolic cognitive unit and one or more prior symbolic cognitive units.

5. The system of claim 1, wherein the recurrence is detected based at least in part on one or more symbolic operators derived from user text, tags, or both.

6. The system of claim 5, wherein the symbolic operators include one or more operators selected from the group consisting of +, /, →, ::, >>, po, and ||.

7. The system of claim 1, wherein the new symbolic cognitive unit created from the reflective output stores references to the one or more source symbolic cognitive units used in the bisociation operation.

8. A computer-implemented method for operating a cognitive operating system, comprising:
receiving user-generated language input at a user device;
creating and storing, in a local data store, a symbolic cognitive unit associated with a recursive session structure;
evaluating the symbolic cognitive unit relative to previously stored symbolic cognitive units to detect recurrence;
selecting one or more prior symbolic cognitive units when a recurrence condition is satisfied;
forming a bisociated input representation from present input and the one or more prior symbolic cognitive units;
transmitting selected textual content derived from the symbolic cognitive unit and the bisociated input representation to a remote generation component;
receiving reflective output from the remote generation component; and
storing the reflective output locally in association with the symbolic cognitive unit or in a new symbolic cognitive unit linked to the one or more prior symbolic cognitive units.

9. The method of claim 8, further comprising re-entering a recursive session structure and re-evaluating one or more previously stored symbolic cognitive units under a current context.

10. A non-transitory computer-readable medium storing instructions that, when executed by one or more processors of a computing device, cause the computing device to:
receive user-generated language input;
generate a symbolic cognitive unit comprising user input text, one or more symbolic tags, one or more timestamps, and a session association;
store the symbolic cognitive unit locally within a recursive session structure;
evaluate the symbolic cognitive unit relative to previously stored symbolic cognitive units to detect recurrence;
selectively transmit textual content derived from the symbolic cognitive unit and optionally one or more prior symbolic cognitive units to a remote generation component that does not maintain persistent user-specific memory after request completion;
receive reflective output from the remote generation component;
store the reflective output locally in association with the symbolic cognitive unit or in a new symbolic cognitive unit linked to one or more source symbolic cognitive units; and
enable recursive re-entry into previously stored recursive session structures for additional evaluation.
